(19) United States
(12) Patent Application Publication
(10) Pub. No.: US 2006/0152367 A1
(43) Pub. Date: Jul. 13, 2006

(54) System and method to reduce errors, authenticate, and reduce the filling time of medical prescriptions by utilizing RFID tag

(75) Inventor: Karthikeyan Narayanaswamy, Canton, MI (US)

Correspondence Address: KARTHIKEYAN NARAYANASWAMY, 2831 WOODMONT DR. W, CANTON, MI, 48188, US

(73) Assignee: Mr. Karthikeyan Narayanaswamy, Canton, MI (US)

(21) Appl. No.: 10/905,399

(22) Filed: Dec. 30, 2004

(51) Int. Cl. G08B 13/14

(52) U.S. Cl. 340/572.1

(57) ABSTRACT

Medical prescription data is electronically written or captured with a RFID scanner device to an RFID tag. This RFID tag can be attached to a written or printed form of the prescription. This prescription RFID tag is read at the pharmacy using a RFID reader. The data written to the RFID tag contains prescription related information and optionally an encryption key to authenticate the prescription. The scanners and readers can be connected in a network link to a host environment. The RFID tag is optionally removed from the written prescription and attached to the medicine container in which the medicine is dispensed, at the pharmacy.

### BACKGROUND

A medical prescription (FIG. 1) provided to a patient by a medical practitioner is an important method of communication where it is important to ensure that the prescribed and intended medicine and dosage is dispensed to the patient at the pharmacy. Accurately and efficiently filled prescriptions play a significant role in health care provided.

Therefore careful and error proof communication is necessary from the health care practitioner to the patient and the pharmacy. Authenticating prescriptions at the pharmacy is important to avoid fraud.

Currently conventional prescription method uses a health care practitioner hand writing the medical prescription (1) on media, commonly made of paper (1a). This prescription (1) includes information such as the name of the facility (2) and title of the practitioner (3) providing the prescription. Some times the prescription is written on media that is printed with ink or markings that are difficult to duplicate. This is done to reduce fraud.

These conventionally used methods are prone to error since mistakes are possible when the prescription is written, such as wrong dosage. Misinterpretation of the hand written prescription, at the pharmacy is also possible. Also, there is no robust method to verify if a prescription is authentic. Reading prescriptions manually and filling them is also a time consuming portion of the prescription filling process, and is not efficient utilization of the licensed pharmacist's time.

Hence, there is a need in the art for an improved prescription system and method.

### SUMMARY

It is accordingly an object of the present invention to utilize RF ID tags (8) for medical prescriptions. Radio frequency identification (RFID) is an automatic data capture technology that comprises small data-carrying tokens (‘tags’), the prescription data can be electronically written (11) to the RFID tags, using fixed or mobile scanners (10). These tags will be referred to as ‘Prescription RFID tags’ (8) in this document. These tags can be physically applied (attached) to a conventional written prescription by glue or other suitable means. A written or typed prescription thus carrying a ‘prescription RFID tag’ (8) with it is to be referred to as ‘RFID tagged prescription’ (5). Scanners (10) may be installed at locations where these ‘RFID tagged prescriptions’ (5) are filled. Data captured in the ‘prescription RFID tags’ (8) may include but not limited to patient information, health care provider information, and health care practitioner information, the medicine being prescribed, including dosage amounts, any other significant notes and encryption keys. This data is then read using a reader (15) at the pharmacy or any location that fills the prescription. The readers (15) and scanners (10) can be connected in a network (16) communication link to a host environment (19). When the ‘prescription RFID tag’ (8) is read using a reader (15) at the pharmacy, the data can be used for error checking the dosage amount, authenticating the prescription by deciphering the encryption code in a computer connected to the reader and the time that would otherwise be spent in manually reading, authenticating the prescription is eliminated. Readers and tags communicate using low power radio frequency (RF) signals. RFID tags typically are based on a custom designed silicon integrated circuit. Data may be read from and written to tags by readers.

This method at least goes someway to addressing afore mentioned disadvantages or which will at least provide the public with a useful choice.

### DETAILED DESCRIPTION

An embodiment of the invention will now be described by way of example only with reference to the accompanying drawings in which FIG. 2a shows a preferred embodiment of the written medical prescription attached with an RFID tag (to be referred to as ‘RFID tagged medical prescription’). It is to be understood that Radio frequency identification (RFID) is an automatic data capture (ADC) technology that comprises small data-carrying tokens (‘tags’) (8), and fixed or mobile scanners (10) and readers (15). RFID tags are attached to or embedded in objects to be identified. Readers may be installed at locations where data capture is required, and may also be in the form of portable readers.

Data captured from RFID tags is transferred between distributed readers and a host environment via wire or wireless serial communications links (16).

Scanners or Readers (10, 15) and tags (8) communicate using low power radio frequency (RF) signals. Tags (8) typically are based on a custom designed silicon integrated circuit (7). Data may be written to RFID tags by scanners (10) and read from tags with readers (15).

The ‘prescription RF ID tag’ (8) consists of the following major physical components: An integrated circuit (7), containing the circuitry to read, store and transmit data. There is an antenna (9). These components are housed in a housing (8a) that is made with suitable material.

A health care practitioner, who is providing a prescription to a patient, uses an RFID scanner that may be handheld (10) to electronically write the prescription data to the RFID tag that can accept this data (12). This data may include patient information, health care provider information, and health care practitioner information, the medicine being prescribed, including dosage amounts, any other significant notes and optionally encryption keys comprising of numbers and or alphabets, generated using software could also be written to the RFID tag.

This RFID tag (8) is attached by a suitable means such as glue (17) (FIG. 2b) to a prescription (5a) made with paper or any other suitable media. The healthcare practitioner also hand writes or types the prescription on the media (5a). The prescription media (5a) thus attached with a RFID tag (8) is to be called as a ‘RFID tagged prescription’ (5). Attaching the RFID tag to the written prescription may also be accomplished by means other than gluing, such as stitching, welding, laminating, etc.

At the pharmacy, a RFID reading device (15) that may be portable is utilized to read the information from the RFID prescription tag that contains prescription data (13). Encryption key can also be read and deciphered using software to authenticate the prescription. This information is used to fill the prescription.

Optionally the data from the RFID tag could be used for verifications such as the prescribed medicine and or dosage amounts with typical dosage amounts, thus checking for any possible errors or warnings.

Optionally, as shown in the FIG. (2c) the RFID prescription tag (8) can be attached to the container (18) in which the medicine is provided to the patient. Thus this prescription RFID tag can be read again, when this same container with the prescription tag is brought back by the patient for refills of the medicine if any required.

In an alternate embodiment FIG. (2c), the RF ID tag's (8) housing (8a) itself could be used as a media to write or print the written form of the prescription.

### BRIEF DESCRIPTION OF DRAWINGS

FIG. 1 shows a view of a typical medical prescription written on media such as paper

FIG. 2a illustrates a view of one preferred embodiment of the ‘RFID tagged medical prescription’

FIG. 2b illustrates a view of the ‘RFID tagged medical prescription’ showing the attachment method of the RFID tag to the written prescription media

FIG. 2c illustrates a view of another embodiment of the ‘RFID tagged medical prescription’

FIG. 2d illustrates a view of the prescription RFID tag attached to a medicine container

FIG. 3 illustrates the writing and reading process to the prescription tag

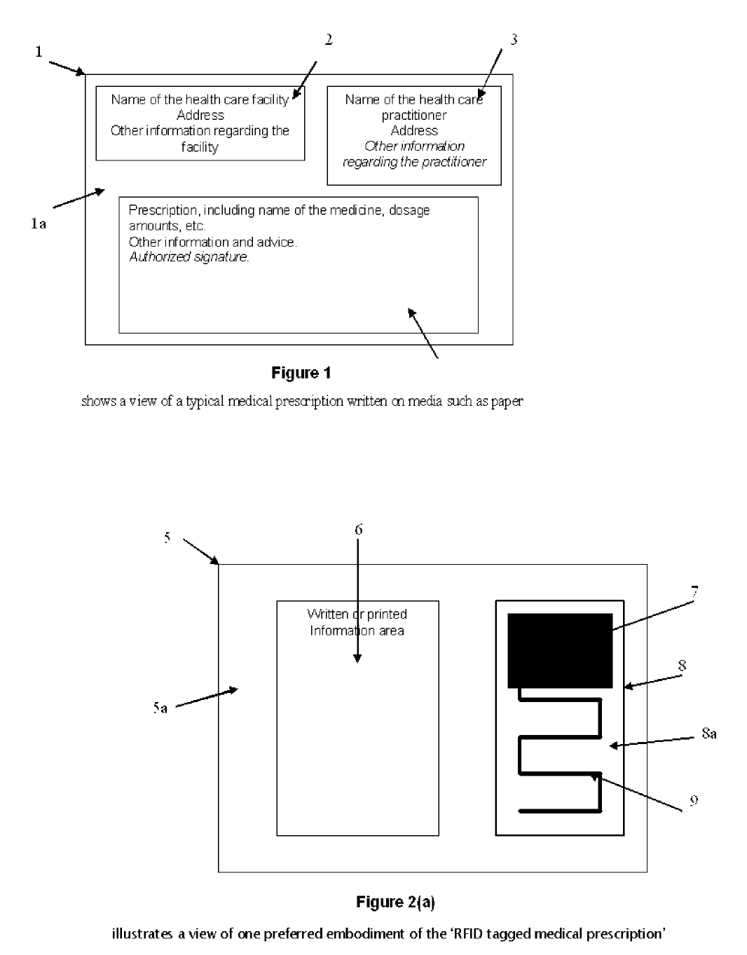

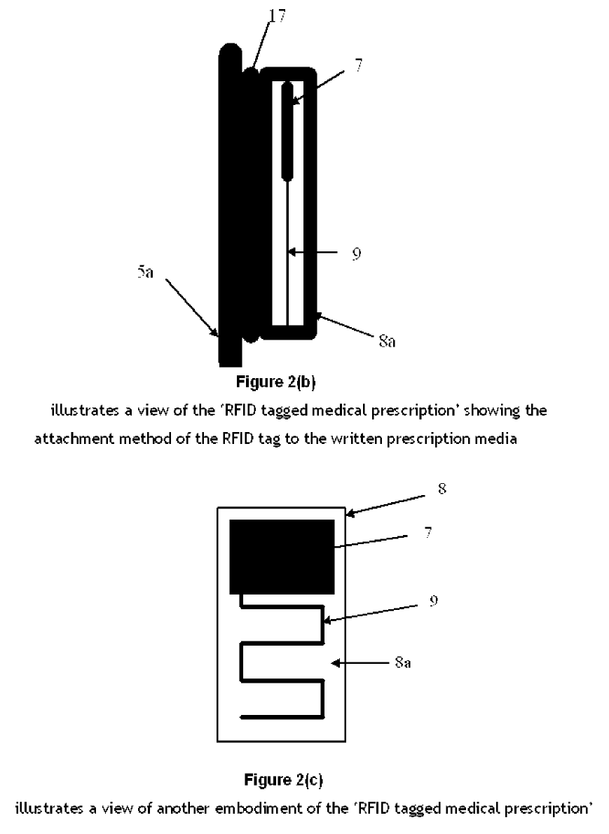

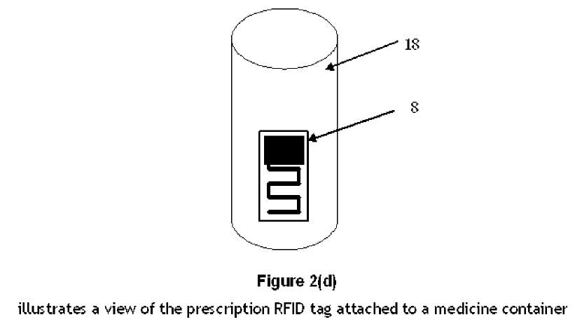

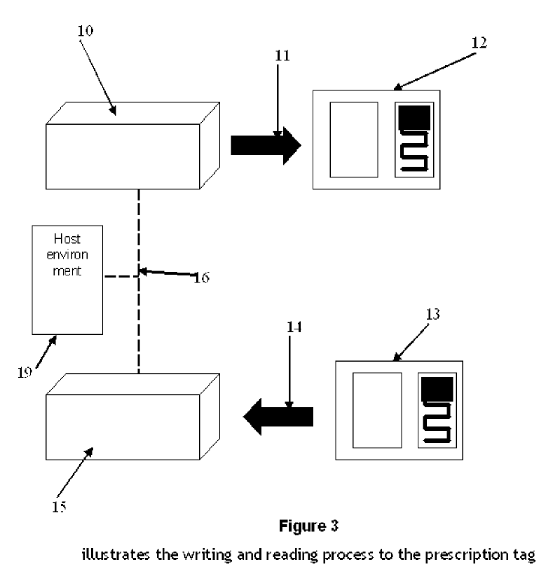

What is claimed is:

1. Apparatus carrying Medical prescription as electronic data, said apparatus as
a unit comprising or including
a circuit including at least a RF signal receiving and processing circuitry, RF signal
transmitting circuitry, electronic data storage and an antenna
a housing which at least partially contains the circuit and antenna
whereby the housing retains the circuit.

2. Apparatus as claimed in claim 1 wherein said apparatus is or includes an integrated circuit.

3. Apparatus as claimed in claim 1 wherein said transmitter element is of a kind to send said signal via said antenna by electromagnetic frequency.

4. Apparatus as claimed in claim 1 wherein said signal is in the radio frequency spectrum.

5. Apparatus as claimed in claim 1 wherein said antenna and said transmitter element are adapted to receive as well as transmit.

6. Apparatus as claimed in claim 1 is an RFID tag.

7. Apparatus as claimed in claim 1 is secured to a written or printed medical prescription media surface whereby the said housing retains the circuit and the housing itself is engaged to said written or printed prescription media surface by stitching.

8. Apparatus as claimed in claim 1 is secured to a written or printed medical prescription media surface whereby the said housing retains the circuit and the housing itself is engaged to said written or printed prescription media surface by lamination.

9. Apparatus as claimed in claim 1 secured to a written or printed medical prescription media surface whereby the said housing retains the circuit and the housing itself is embedded in the said written or printed prescription media surface.

10. Apparatus as claimed in claim 1 carrying the said medical prescription data in electronic form is attached to the surface of a medicine container whereby the said housing retains the circuit and the housing itself is engaged to said medicine container surface by adhesive means.

11. Apparatus as claimed in claim 1 the said medical prescription data in electronic form contains one or all of the following data but not limited to the patient's name, an encryption key, the name of the medicine prescribed, dosage amounts, name of the health care facility, health care practitioner's license ID.

12. Apparatus as claimed in claim 1 is secured to a written or printed medical prescription media surface whereby the said housing retains the circuit and the housing itself is engaged to said written or printed prescription media surface by adhesive means.

13. Apparatus as claimed in claim 12 wherein said apparatus is serially packaged with adhesive pre-applied.

14. Apparatus as claimed in claim 13 wherein a removable liner protects said adhesive.

15. A method of remotely receiving medical prescription related data, storing means for this data and transmitting means located inside a housing, said housing is in turn secured to a media surface of a written or typed medical prescription.

16. Apparatus as claimed in claim 15 the said medical prescription data includes an encryption code intended for authenticating the medical prescription.

17. A written or printed medical prescription with a unit carrying medical prescription as electronic data secured to the surface of said medical prescription media, wherein said unit comprises or includes, a sensing apparatus comprising at least an element to receive prescription data, a storage element to store this received data, a signal processing element to process output from said storage element, a transmitter element to send the prescription data from said signal processing element via an antenna to transmit said signal, and
a housing to at least partially contain said apparatus,
wherein said unit is mounted to a written or printed medical prescription media surface.
